(19) United States
(12) Patent Application Publication
(10) Pub. No.: US 2017/0061063 A1
(43) Pub. Date: Mar. 2, 2017

(54) INTEGRATED CIRCUIT WITH REDUCED ROUTING CONGESTION

(71) Applicant: QUALCOMM Incorporated, San Diego, CA (US)

(72) Inventors: Vinod Gupta, Bangalore (IN); Rajiv Mittal, Bangalore (IN); Abhishek Chouksey, Jabalpur (IN)

(21) Appl. No.: 14/839,687

(22) Filed: Aug. 28, 2015

(51) Int. Cl. G06F 17/50

(52) U.S. Cl. CPC G06F 17/5081; G06F 17/5072; G06F 17/5077

(57) ABSTRACT

Systems and methods for reducing routing congestion in an integrated circuit allow an integrated circuit floorplan to be modified, for example, after cell placement and global routing. Modifying the floorplan can avoid delays in time to market for the integrated circuit and can avoid increasing the size of the integrated circuit. Reducing routing congestion includes adding routing congestion reduction regions in cell/routing regions of the floorplan. The routing congestion reduction regions may modify how cells can be placed in the region. The routing congestion reduction regions may also modify how connections can be routed in the region. The routing congestion reduction regions may be a halo region that includes modifying preferred routing directions in regions nears edges of hard macros, a hammerhead region that includes laterally expanding the end of the river routing region, and a corner congestion reduction region for use at corners of hard macros.

### FIELD

This disclosure relates to integrated circuits and, more particularly, to reducing routing congestion in the layout of integrated circuits.

### BACKGROUND

As integrated circuits have continued to grow more complex, efficient layout design of integrated circuits has become increasingly important. Prior integrated circuit design techniques result in design times that are not reliably predictable. Moreover, the sizes of the resulting integrated circuits are also not reliably predictable. Thus, neither the time when a product will be available nor the cost of the product is reliably predictable. The design time can be longer than expected and the die size can be larger than expected.

### SUMMARY

In one aspect, an integrated circuit is provided. The integrated circuit includes: a plurality of hard macros containing fixed circuits; a plurality of cell/routing regions containing cells and interconnect routing using a plurality of metal layers; and one or more routing congestion reduction regions located in one or more of the plurality of cell/routing regions, wherein the one or more routing congestion reduction regions are selected from a hammerhead region, a corner congestion reduction region, and a halo region, wherein if one of the plurality of cell/routing regions contains a halo region, the interconnect routing in the cell/routing region containing the halo region has a preferred routing direction and the interconnect routing in the halo region has a different preferred routing direction.

In another aspect, a method is provided for developing an integrated circuit using a floorplan that includes a plurality of hard macros and a plurality of cell/routing regions for placement of cells and routing or interconnects using a plurality of metal layers. The method includes: placing cells and preforming a global route of the integrated circuit based on a floorplan of the integrated circuit; evaluating results of the global route for routing congestion; modifying, based on the routing congestion, the floorplan by adding one or more routing congestion reduction regions to one or more of the plurality of cell/routing regions, the one or more routing congestion reduction regions selected from a halo region located at an edge of one of the plurality of the hard macros, wherein interconnect routing in the cell/routing region containing the halo region has preferred routing directions and wherein the preferred routing directions are modified in the halo region, a hammerhead region, wherein interconnect routing in the cell/routing region containing the hammerhead region has preferred routing directions, wherein the cell/routing region containing the hammerhead region includes a river routing region, the river routing region being an area where cell placement is excluded and preferred routing directions are modified to increase routing capacity, and wherein the hammerhead region expands an end of the river routing region laterally, and a corner congestion reduction region located at a corner of one of the plurality of hard macros; and placing cells and preforming a global route of the integrated circuit based on the modified floorplan.

In another aspect, an integrated circuit is provided. The integrated circuit includes: a plurality of hard macros containing fixed circuits; a plurality of cell/routing regions containing cells and interconnect routing using a plurality of metal layers; and one or more means for reducing routing congestion located in one or more of the plurality of cell/routing regions.

In another aspect, a non-transitory computer readable medium is provided. The non-transitory computer readable medium comprises instructions that, when executed by a processor, cause the processor to perform operations for developing an integrated circuit using a floorplan including a plurality of hard macros and a plurality of cell/routing regions, the cell/routing regions for placement of cells and routing of interconnects using a plurality of metal layers. The instructions comprising instructions that cause the processor to: place cells and perform a global route of the integrated circuit based on a floorplan of the integrated circuit; evaluate results of the global route for routing congestion; modify, based on the routing congestion, the floorplan by adding one or more routing congestion reduction regions to one or more of the plurality of cell/routing regions, the one or more routing congestion reduction regions selected from a halo region located at an edge of one of the plurality of the hard macros, wherein interconnect routing in the cell/routing region containing the halo region has preferred routing directions and wherein the preferred routing directions are modified in the halo region, a hammerhead region, wherein interconnect routing in the cell/routing region containing the hammerhead region has preferred routing directions, wherein the cell/routing region containing the hammerhead region includes a river routing region, the river routing region being an area where cell placement is excluded and preferred routing directions are modified to increase routing capacity, and wherein the hammerhead region expands an end of the river routing region laterally, and a corner congestion reduction region located at a corner of one of the plurality of hard macros; and place cells and perform a global route of the integrated circuit based on the modified floorplan.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a flowchart of a process for developing an integrated circuit;

FIG. 1B is a flowchart of a process for developing an integrated circuit according to a presently disclosed aspect;

FIG. 2 is a layout diagram of an integrated circuit floorplan according to a presently disclosed aspect;

FIG. 3A is a layout diagram of area 3 of the integrated circuit of FIG. 2 showing routing congestion;

FIG. 3B is a layout diagram of area 3 of the integrated circuit of FIG. 2 showing reduction of routing congestion according to a presently disclosed aspect;

FIG. 4A is a layout diagram of area 4 of the integrated circuit of FIG. 2 showing routing congestion;

FIG. 4B is a layout diagram of area 4 of the integrated circuit of FIG. 2 showing reduction of routing congestion according to a presently disclosed aspect;

FIG. 4C is a layout diagram illustrating a river routing region with a hammerhead region according to a presently disclosed aspect;

FIG. 4D is another layout diagram illustrating a river routing region with another hammerhead region according to a presently disclosed aspect;

FIG. 5A is a layout diagram of area 5 of the integrated circuit of FIG. 2 showing reduction of routing congestion according to a presently disclosed aspect;

FIG. 5B is a layout diagram of area 5 of the integrated circuit of FIG. 2 showing another reduction of routing congestion according to a presently disclosed aspect;

FIG. 5C is a layout diagram of area 5 of the integrated circuit of FIG. 2 showing another reduction of routing congestion according to a presently disclosed aspect;

FIG. 5D is a layout diagram of area 5 of the integrated circuit of FIG. 2 showing another reduction of routing congestion according to a presently disclosed aspect; and

FIG. 6 is a block diagram of a system for developing an integrated circuit according to a presently disclosed aspect.

### DETAILED DESCRIPTION

The detailed description set forth below, in connection with the accompanying drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in simplified form in order to avoid obscuring such concepts.

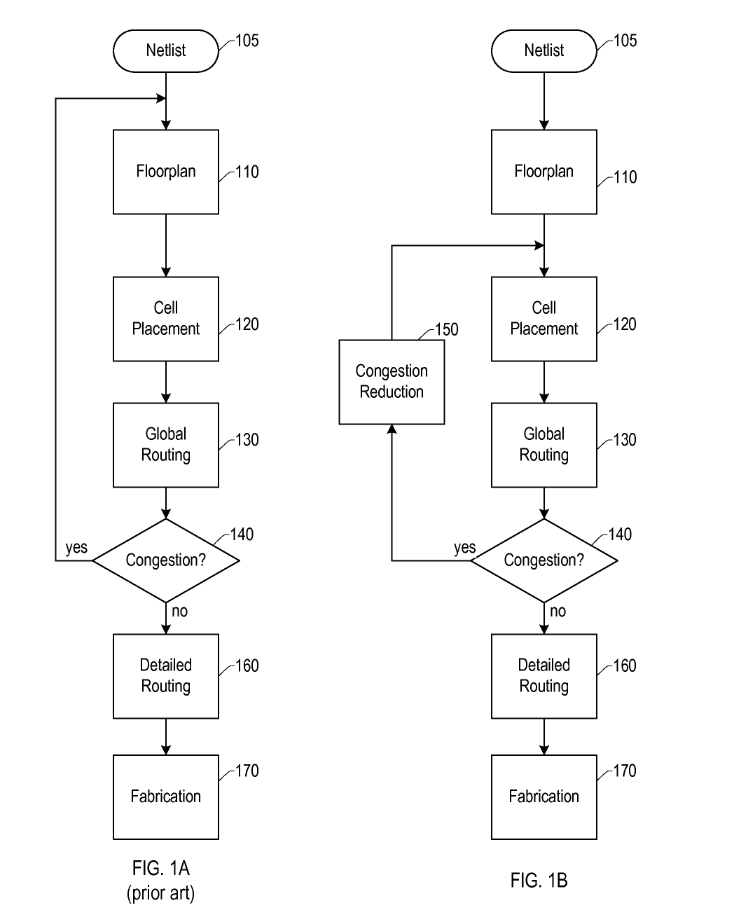

FIG. 1A is a flowchart of a process for developing an integrated circuit. The process may be performed, for example, by integrated circuit designers using computer aided design (CAD) tools. The process begins with a netlist 105 that describes the components of the integrated circuit and how the components are to be connected. The components may range from small cells, such as standard cells formed of small number of transistors, to large components, such as microprocessors or memories. The netlist 105 may be created, for example, by synthesis of a register-transfer level (RTL) description of the integrated circuit. The netlist 105 may include or be associated with additional information such as characteristics of the components used to form the integrated circuit.

In block 110, the integrated circuit designers create a floorplan for the integrated circuit. The floorplan indicates the size of the integrated circuit and where the components of the integrated circuit will be located in the integrated circuit. Areas in the floorplan may be designated, for example, for hard macros, standard cell placements, interconnect routing, or a combination of uses (e.g., for standard cell placements and interconnect routing). Hard macros have fixed physical shapes. Example hard macros include analog circuits, memories, and macros of previously placed and routed standard cells. Hard macros may be viewed as containing fixed circuits since the layout of circuits in the hard macros is not modified by the process of FIG. 1A. The layouts of hard macros may be modified by other means.

In block 120, the integrated circuit designers use a CAD tool to place cells (e.g., standard cells) in the integrated circuit layout. The cells are placed in locations based on the floorplan. Cell placement may be chosen to reduce interconnect routing.

In block 130, the integrated circuit designer uses a CAD tool to perform a global route to interconnect the components of the integrated circuit. The global routing connects both components located by the floorplan and components located by the cell placement of block 120. A global router is used as a first-pass routing tool to arrange routes across a floorplan. The global router may divide the floorplan into local routing regions and locate routes between the local routing regions.

The global route can include routing overflows (areas where the global routing placed more routes than the available space can contain) associated with a number of local routing regions. Thus, the results of the global routing in block 130 also include indications of routing congestion. For example, the global routing may graphically display areas of the floorplan with routing congestion. The areas of routing congestion are where the global routing placed more routes than the available space can contain.

In block 140, the integrated circuit designers evaluate whether routing congestion from the global routing of block 130 is acceptable. Since a detailed route (e.g., in block 160) can generally fix a limited amount of routing congestion, the routing congestion need not be zero to be acceptable. Whether the routing congestion is acceptable may be based, for example, on the number of routes that are in congested areas, number of congested areas, and size of the congested areas. If the routing congestion is determined to be acceptable, the process continues to block 160; otherwise, the process returns to block 110 where the floorplan is modified, for example, by increasing the size of the integrated circuit to allow more space for routing. Increasing the size of the integrated circuit also increases the cost of the resulting integrated circuit. Additionally, returning to block 110 to modify the floorplan can delay time to market for the integrated circuit.

In block 160, the integrated circuit designers use a CAD tool to perform a detailed route to interconnect the components of the integrated circuit. The detailed routing uses the global routing information from block 140 to produce exact routing of each interconnection in the integrated circuit. The detailed routing may fail to route the floorplan, for example, when the routing congestion is too great. Since the detailed routing takes a long time due to very high runtimes (e.g., more than one week) a failed detailed route can delay time to market for the integrated circuit.

In block 170, the integrated circuit layout from block 160 is used to fabricate integrated circuits. Fabrication of the integrated circuits may be performed, for example, in a semiconductor foundry using a complementary metal-oxide semiconductor (CMOS) process.

Evaluations of whether the integrated circuit layout will be suitable for manufacturing may occur at many points in the process. The development process, when the evaluation is negative, returns to an earlier block where one or more aspects of the integrated circuit design are modified. Avoiding design iterations or reducing the number of iterations aids in achieving a short and predicable development time. Additionally, the process may be improved when modifications to the integrated circuit design are limited in scope and occur early in the process.

FIG. 1B is a flowchart of a process for creating an integrated circuit according to a presently disclosed aspect. The process is similar to the process of FIG. 1A with like named blocks operating in like fashion except for described differences.

The process receives a netlist 105 that describes the components of the integrated circuit and how the components are to be connected. In block 110, the integrated circuit designers create a floorplan for the integrated circuit. In block 120, the integrated circuit designers use a CAD tool to place cells in the integrated circuit layout. In block 130, the integrated circuit designers use a CAD tool to perform a global route to interconnect the components of the integrated circuit.

In block 140, the integrated circuit designers evaluate whether routing congestion from the global routing of block 130 is acceptable. If the routing congestion is determined to be acceptable, the process continues to block 160; otherwise, the process continues to block 150.

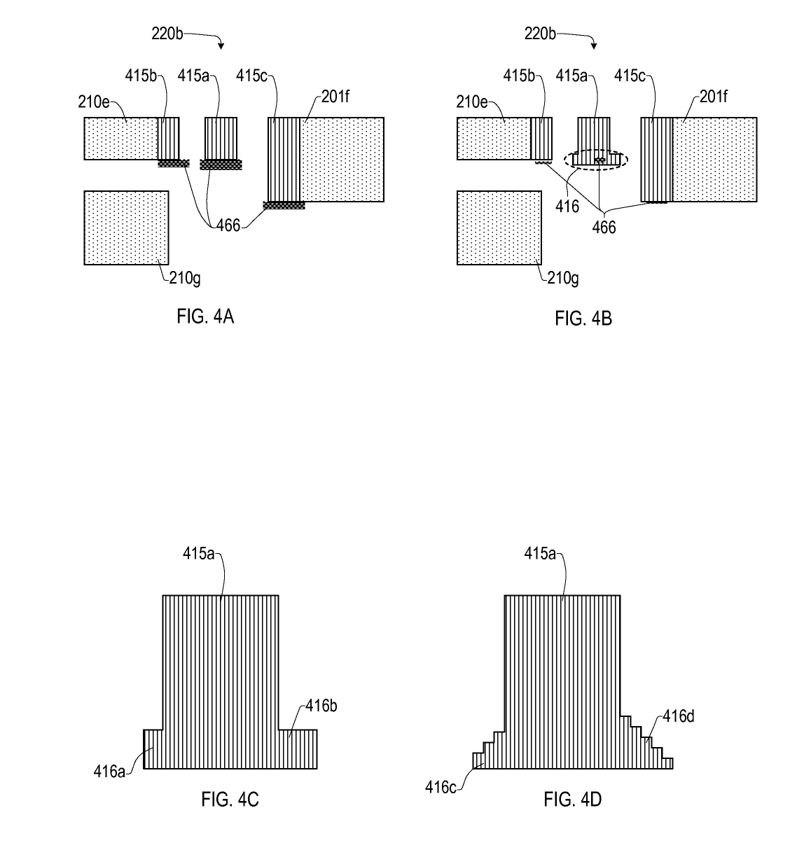

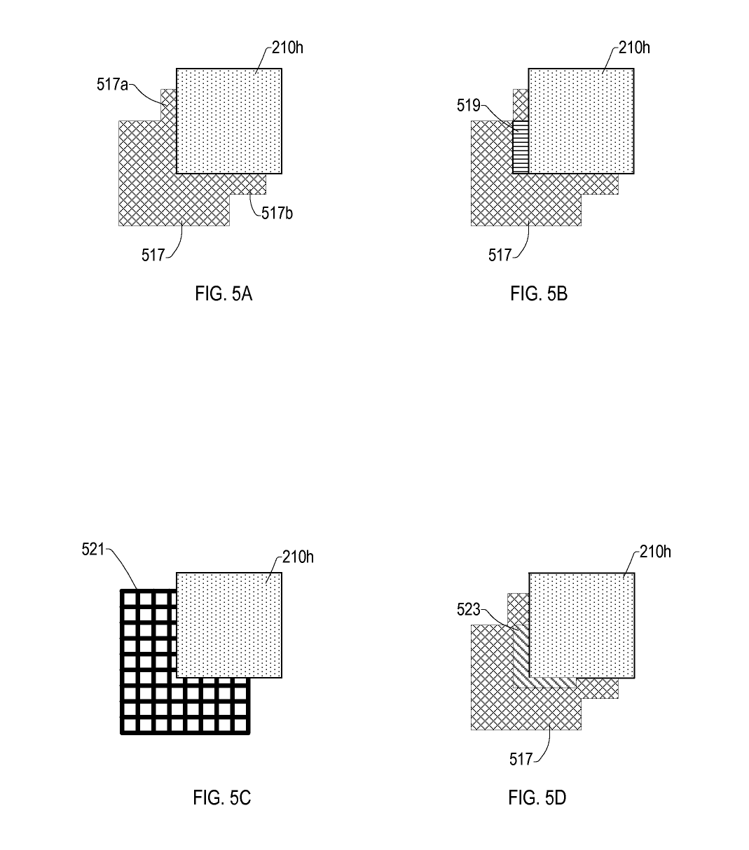

In block 150 congestion reduction is performed on the floorplan. The congestion reduction may include a) halo regions, b) hammerhead regions, c) corner congestion reduction regions, or a combination of techniques. Halo regions are described in detail below, for example, with reference to FIG. 3. Hammerhead regions are described in detail below, for example, with reference to FIGS. 4B, 4C, and 4D. Corner congestion reduction regions are described in detail below, for example, with reference to FIGS. 5A, 5B, 5C, and 5D. The congestion reduction regions may include limitations on cell placement and interconnect routing. After congestion reduction, the process returns to block 120, block 130, and then to block 140 where routing congestion of the floorplan with congestion reduction is evaluated.

In block 160, the integrated circuit designers use a CAD tool to perform a detailed route to interconnect the cells of the integrated circuit. Limitations from the congestion reduction of block 150 may be removed during the detailed route. In block 170, the integrated circuit layout from block 160 is used to fabricate integrated circuits.

The process illustrated in FIG. 1B is subject to many variations, including adding, omitting, reordering, or altering blocks. Additionally, blocks may be performed concurrently.

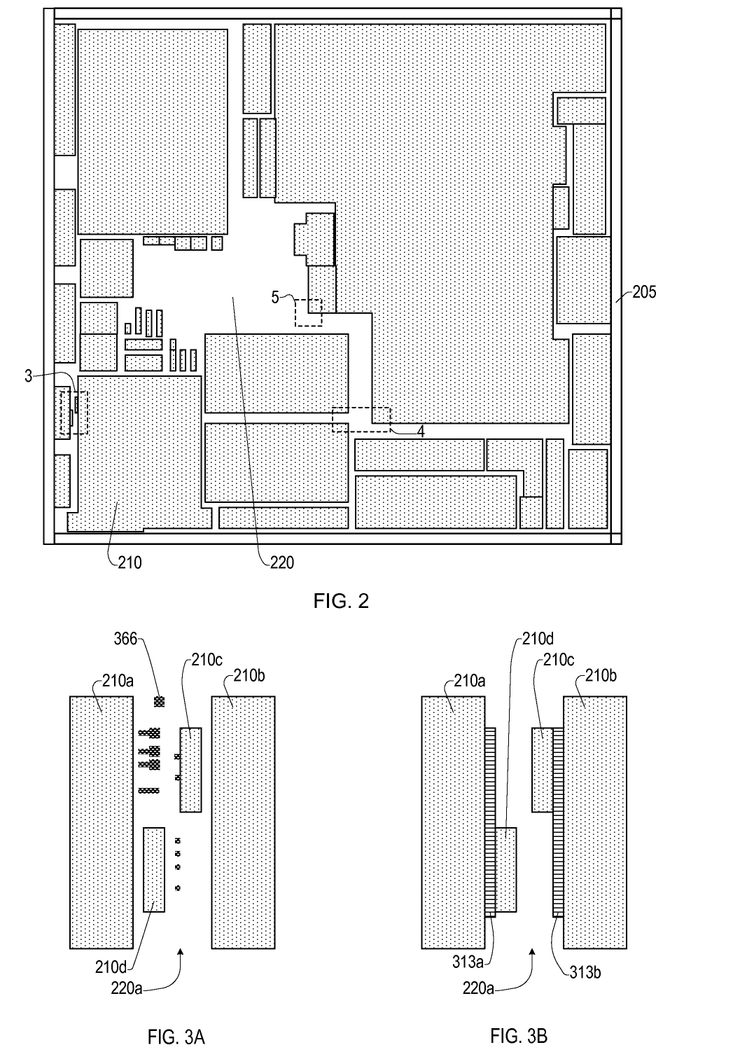

FIG. 2 is a layout diagram of an integrated circuit floorplan according to a presently disclosed aspect. FIG. 2 may be referred to as a top view. This is the view commonly used for designing the layout of an integrated circuit. The floorplan may be used with the processes of FIG. 1B.

The floorplan includes periphery blocks 205 located along the edges of the integrated circuit. The periphery blocks 205 include circuits to interface to devices outside the integrated circuit. The periphery blocks 205 may also include other components.

The floorplan includes hard macros 210 located internal to the periphery blocks 205. The hard macros 210 in the example floorplan of FIG. 2 vary greatly in size and shape. The hard macros 210 provide many of the functions of the integrated circuit.

The floorplan includes cell/routing regions 220 located in areas of the floorplan not occupied by the hard macros 210 or the periphery blocks 205. The cell/routing regions 220 may be used for cell placement and interconnect routing. Portions of the cell/routing regions 220 may be restricted to cell placement or interconnect routing. Portions of the cell/routing regions 220 may also be restricted to other usage limitations.

An example usage limitation is the application of preferred and non-preferred directions for interconnect routing. A routing tool may, for example, use information about the preferred directions to apply a large cost to the non-preferred directions so that the non-preferred directions are rarely used. Additionally, the preferred and non-preferred directions may be set to orthogonal directions for a metal layer so that only one direction is used on that metal layer. The preferred and non-preferred directions generally alternate between metal layers. For example, when the preferred routing direction for the first metal layer is vertical, the preferred routing direction for the second metal layer is horizontal, the preferred routing direction for the third metal layer is vertical, and so on. Additionally, the preferred and non-preferred directions may differ between portions of the cell/routing regions 220.

The floorplan of FIG. 2 is an example. Many variations are possible and may be used with the disclosed techniques.

FIGS. 3-5 illustrate routing congestion reduction techniques. The techniques will be described with reference to the integrated circuit floorplan of FIG. 2 and the development process of FIG. 1B but may be used with any suitable integrated circuit floorplan or process. The techniques may be used individually or in combination.

FIG. 3A is a layout diagram of area 3 of the integrated circuit floorplan of FIG. 2 showing routing congestion. Area 3 includes a first hard macro 210a and a second hard macro 210b. The first hard macro 210a and the second hard macro 210b shown in FIG. 3A are portions of larger hard macros. Area 3 also includes a cell/routing region 220a located between the first hard macro 210a and the second hard macro 210b. The cell/routing region 220a is used for cell placement and interconnect routing. Area 3 also includes a third hard macro 210c and a fourth hard macro 210d. The third hard macro 210c and the fourth hard macro 210d are also located between the first hard macro 210a and the second hard macro 210b.

Area 3, in FIG. 3A, includes regions of routing congestion 366. The routing congestion 366 may be indicated by a global routing tool (e.g., in block 130). The routing congestion 366 tends to occur near the third hard macro 210c and the fourth hard macro 210d. The routing congestion 366 may be due to a large number of connections to the hard macros. For example, there may be a shortage of vertical (in the orientation of FIG. 3A) routing tracks. The routing congestion 366 can cause, for example, failures in detailed routing or redoing the floorplan.

FIG. 3B is a layout diagram of area 3 of the integrated circuit floorplan of FIG. 2 showing reduction of routing congestion according to a presently disclosed aspect. In FIG. 3B, halo regions 313a, 313b (collectively 313) are added to the integrated circuit floorplan. The halo regions 313 are located in the cell/routing region 220a along edges of the first hard macro 210a and the second hard macro 210b. The halo regions 313 extend, for example, 2 to 5 microns from the edges of the first hard macro 210a and the second hard macro 210b. Although the halo regions 313 illustrated in the layout area of FIG. 3B are near smaller hard macros (the third hard macro 210c and the fourth hard macro 210d) located in the cell/routing region 220a between larger hard macros (the first hard macro 210a and a second hard macro 210b), similar halo regions may be used in other areas with routing congestion. For example, similar routing congestion may occur when a hard macro (e.g., the third hard macro 210c or the fourth hard macro 210d) includes pins located in the channel.

The halo regions 313 are used to exclude placement of cells in the halo regions 313. Exclusion of cells from the halo regions 313 may prevent the occurrence of design-rule violations between places cells and the hard macros 210.

In addition, the usage of the metal routing layers can be modified in the halo regions 313. Since the cell/routing region 220a generally runs vertically, there may, in particular, be congestion in the vertical routing. By modifying the preferred routing directions in the halo regions 313, the congestion in the vertical routing may be alleviated. For an example six-metal process, the preferred routing directions may be horizontal for the first, third, and fifth metal layers and vertical for the second, fourth, and sixth metal layers. In the halo regions 313, the preferred routing direction for the first metal layer can be changed to vertical.

The preferred routing direction for the first metal layer in the cell/routing region 220a is generally the direction that the first metal layer is used in cells placed in the cell/routing region 220a. In an example aspect, the preferred routing direction for the first metal layer in the halo regions 313 is changed from vertical to horizontal (or horizontal to vertical) relative to the preferred routing direction in the cell/routing region 220a. The change in preferred routing directions in the halo regions 313 can increase the amount of routing resources available and thereby reduce the congestion. For example in the layout diagram of FIG. 3B, there are no regions of routing congestion. This reduction in routing congestion can allow the existing floorplan to be used and rework or increase in die size can be avoided. The halo regions may also reduce interconnect crosstalk.

FIG. 4A is a layout diagram of area 4 of the integrated circuit floorplan of FIG. 2 showing routing congestion. Area 4 includes a fifth hard macro 210e, a sixth hard macro 210f, and a seventh hard macro 210g. The fifth hard macro 210e, the sixth hard macro 210f, and the seventh hard macro 210g shown in FIG. 4A are portions of larger hard macros.

Area 4 also includes a cell/routing region 220b located between the first hard macro 210a and the second hard macro 210b. The cell/routing region 220b is used for cell placement and interconnect routing. In the example floorplan, the cell/routing region 220b of area 4 is part of a vertical channel (as shown in FIG. 2). Also, in the example floorplan, the cell/routing region 220b is used to route many interconnections. The cell/routing region 220b includes river routing regions 415 including a central river routing region 415a, a left river routing region 415b, and a right river routing region 415c. The river routing regions 415 are rectangular in FIG. 4A. The river routing regions 415 are used to increase the capacity for vertical routing in the cell/routing region 220b. Cell placement may be excluded in the river routing regions 415. Additionally, the preferred routing directions may also be modified to use more metal layers for vertical routing.

Although the river routing regions 415 can increase the capacity for vertical routing in the cell/routing region 220b, this can cause regions of routing congestion 466 at the ends of the river routing regions 415. The routing congestion 466 may occur because of the change in preferred routing from the river routing regions 415 to the cell/routing region 220b. The routing congestion 466 may also occur because of a need to place many buffers at the ends of the river routing regions 415. Changes in direction of the interconnections routed in the river routing regions 415 may also cause routing congestion 466. The routing congestion 466 may lead, for example, to development delays or increased die size.

FIG. 4B is a layout diagram of area 4 of the integrated circuit floorplan of FIG. 2 showing reduction of routing congestion according to a presently disclosed aspect. In FIG. 4B, a hammerhead region 416 is added at the end of the central river routing region 415a. The hammerhead region 416 expands the central river routing region 415a laterally. The lateral extension of the river routing region by the hammerhead region can reduce congestion by allowing the routing at the end of the river routing region to spread over a larger area. This, in the example of FIG. 4B, reduces the routing congestion 466 to an acceptable level. This routing congestion reduction can allow an existing floorplan to be used and rework or an increase in die size to be avoided.

FIG. 4C is a layout diagram illustrating a river routing region with a hammerhead region according to a presently disclosed aspect. The hammerhead region of FIG. 4C may be used, for example, with the central river routing region 415a of FIG. 4B.

The hammerhead region of FIG. 4C includes a left hammerhead region 416a extending the end of the central river routing region 415a on the left and a right hammerhead region 416b extending the end of the central river routing region 415a on the right. The left hammerhead region 416a and the right hammerhead region 416b are rectangular. In FIG. 4C, the left hammerhead region 416a is smaller than the right hammerhead region 416b. Alternatively, the left hammerhead region 416a and the right hammerhead region 416b may be differently sized. The sizes of the left hammerhead region 416a and the right hammerhead region 416b may be chosen based on the particular routing congestion in the region. Additionally, the left hammerhead region 416a or the right hammerhead region 416b may be omitted.

FIG. 4D is another layout diagram illustrating a river routing region with a hammerhead region according to a presently disclosed aspect. The hammerhead region of FIG. 4D may be used, for example, with the central river routing region 415a of FIG. 4B.

The hammerhead region of FIG. 4D includes a left hammerhead region 416c extending the end of the central river routing region 415a on the left and a right hammerhead region 416d extending the end of the central river routing region 415a on the right. The left hammerhead region 416c and the right hammerhead region 416d are stair-step shaped with the width of the hammerhead regions increasingly extending the width of the central river routing region 415a towards the end of the central river routing region 415a. As with the hammerhead region of the FIG. 4C, the sizes of the left hammerhead region 416c and the right hammerhead region 416d may be chosen based on the particular routing congestion in the region.

FIG. 4B illustrates a hammerhead region at one end of the central river routing region 415a. Hammerhead regions may be included at both ends of the central river routing region 415a. Hammerhead regions may also be used on the left river routing region 415b and the right river routing region 415c. The hammerhead regions may be the same or different between ends of a river routing region and between different river routing regions. For example, stair-step shaped hammerhead regions may be used on both sides of one end of a river routing region with a rectangular hammerhead region used on one side of the other end of that river routing region.

FIGS. 5A, 5B, 5C, and 5D illustrate techniques for reducing routing congestion near corners of hard macros. Routing congestion may occur in cell/routing regions near the corners of hard macros. The routing congestion may occur, for example, because of changes in direction of interconnections in the area. The routing congestion may increase when cell/routing regions near the corner include river routing regions. Reducing routing congestion using the techniques of FIGS. 5A, 5B, 5C, and 5D can allow an existing floorplan to be used and avoid rework or an increase in die size.

Each of FIGS. 5A, 5B, 5C, and 5D is layout diagram of area 5 of the integrated circuit of FIG. 2 showing corner congestion reduction regions according to presently disclosed aspects. Area 5 includes an eighth hard macro 210h which is a portion of a larger hard macro that extends upward and to the right. The corner of the eighth hard macro 210h is surrounded by a cell/routing region to the left and downward.

The layout diagram of FIG. 5A includes a stepped placement blockage region 517 at the corner of the eighth hard macro 210h. The stepped placement blockage region 517 includes a rectangular region overlapping and extending outward from the corner of the eighth hard macro 210h. The stepped placement blockage region 517 also includes a left step region 517a extending the stepped placement blockage region 517 along the left edge of the eighth hard macro 210h and lower step region 517b extending the stepped placement blockage region 517 along the lower edge of the eighth hard macro 210h. Placement of cells is excluded in the stepped placement blockage region 517. The dimensions of the stepped placement blockage region 517 may be chosen, for example, to be large enough to avoid routing congestion and small enough to not overly exclude cell placement from areas of the cell/routing region near the corner of the eighth hard macro 210h. The stepped placement blockage region 517 may include may include additional left steps or lower steps and the number of left steps or lower steps may differ.

The layout diagram of FIG. 5B includes the stepped placement blockage region 517 at the corner of the eighth hard macro 210h. The stepped placement blockage region 517 may be the same as or similar to the corresponding region of FIG. 5A. The layout diagram of FIG. 5B also includes a non-preferred routing direction region 519.

In the non-preferred routing direction region 519, the preferred routing directions of one or more metal layers is modified compared to the corresponding preferred routing directions in the surrounding cell/routing region. For example, in a six-metal process, the preferred routing directions in the cell/routing region may be horizontal for the first, third, and fifth metal layers and vertical for the second, fourth, and sixth metal layers. In the non-preferred routing direction region 519, the preferred routing direction for the first metal layer can be changed to vertical. By modifying the preferred routing directions, routing congestion in and near the non-preferred routing direction region 519 may be alleviated.

The layout diagram of FIG. 5C includes a mesh placement blockage region 521. The mesh placement blockage region 521 is a rectangular region overlapping and extending outward from the corner of the eighth hard macro 210h. The mesh placement blockage region 521 includes a grid of blockage stripes. Placement of cells is excluded in the blockage stripes. The grids of the mesh placement blockage region 521 may be, for example, 2 microns by 2 microns with the blockage stripes occupying 25% of the area in the mesh placement blockage region 521. The mesh placement blockage region 521 reduces the number of cells placed in the region and thereby reduces routing congestion. Additionally, cells that are placed in the mesh placement blockage region 521 may be cells whose locations are timing critical.

The layout diagram of FIG. 5D includes the stepped placement blockage region 517 at the corner of the eighth hard macro 210h. The stepped placement blockage region 517 may be the same as or similar to the corresponding region of FIG. 5A. The layout diagram of FIG. 5D also includes a routing density blockage region 523.

The routing density blockage region 523 includes a rectangular region overlapping and extending outward from the corner of the eighth hard macro 210h. The routing density blockage region 523 and the stepped placement blockage region 517 may overlap. The maximum density of interconnect routing (e.g., expressed as a number of interconnects in unit width) in the routing density blockage region 523 is restricted to less than the maximum density of interconnect routing in the surrounding cell/routing region. The maximum density of interconnect routing in the surrounding cell/routing region may be set the maximum allowed by the fabrication technology. The restricted routing density may be applied to all or some metal layers. For example, in a six-metal process, the routing density of the third and fifth metal layers may be restricted to 60% of the maximum routing density. The restricted routing density reduces the number of interconnects in that region and thereby reduces routing congestion.

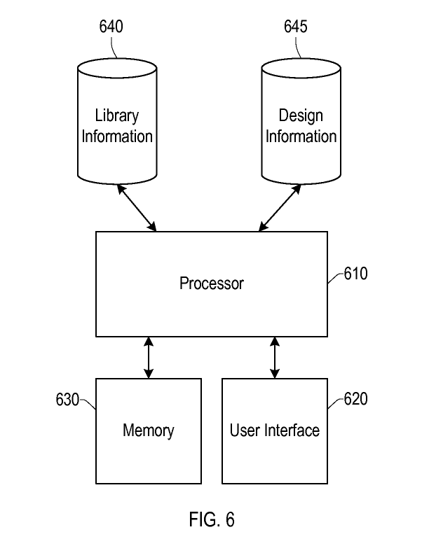

FIG. 6 is a block diagram of a system for developing an integrated circuit according to a presently disclosed aspect. The system may, for example, generate an integrated circuit layout using the process of FIG. 1B. The system of FIG. 6 includes a processor 610 and a memory 630. The memory 630 can store data for use by the processor 610. The memory 630 may also store computer readable instructions for execution by the processor 610. The computer readable instructions can be used by the system for developing an integrated circuit, for example, performing one or more of block 120, block 130, block 140, block 150, and block 160 of the process of FIG. 1B. The memory 630 or parts of the memory 630 may be considered a non-transitory computer or machine readable medium. The system also includes a user interface 620 (e.g., a display terminal) for users (e.g., integrated circuit designers) to receive results from the system and provide inputs to the system.

The system also includes a library information store 640 and a design information store 645. The library information store 640 and the design information store 645 may be computer databases. The databases may be combined or shared. The library information store 640 includes information about hard macros, cells, and interconnect routing available for use in the integrated circuit and may be used, for example, in block 120 and block 130 of the process of FIG. 1B. The design information store 645 includes information about the design of the integrated circuit being developed and may be used, for example, to store the netlist 105, the floorplan of block 110, and the placement and routing results from block 120, block 130, and block 160 of the process of FIG. 1B.

Although particular aspects are described above, many variations of are possible, including, variations using different process technologies and where functions described as being performed by an integrated circuit designer may be performed by a computer automated design tool. Directional terms, such above, below, left, and right, are used to describe some features. This terminology is used to provide clear and concise descriptions. The terms are relative and no particular absolute orientation should be inferred. Additionally, features may be combined in combinations that differ from those described above. Similarly, the grouping of features within a module or block is for ease of description and specific features may be moved from one module or block to another module or block.

The above description is provided to enable any person skilled in the art to make or use the disclosed systems and methods. Various modifications will be readily apparent to those skilled in the art, and the generic principles described herein can be broadly applied. Thus, it is to be understood that the description and drawings presented herein are therefore representative of the subject matter which is broadly contemplated by the present disclosure. It is further understood that the scope of the disclosure fully encompasses other variations that may become obvious to those skilled in the art and that the scope is accordingly limited by nothing other than the appended claims.

What is claimed is:

1. An integrated circuit, comprising:
a plurality of hard macros containing fixed circuits;
a plurality of cell/routing regions containing cells and interconnect routing using a plurality of metal layers; and
one or more routing congestion reduction regions located in one or more of the plurality of cell/routing regions, wherein the one or more routing congestion reduction regions are selected from a hammerhead region, a corner congestion reduction region, and a halo region,
wherein if one of the plurality of cell/routing regions contains a halo region, the interconnect routing in the cell/routing region containing the halo region has a preferred routing direction and the interconnect routing in the halo region has a different preferred routing direction.

2. The integrated circuit of claim 1, wherein the one or more routing congestion reduction regions includes a hammerhead region, wherein the interconnect routing in the cell/routing region containing the hammerhead region has preferred routing directions, wherein the cell/routing region containing the hammerhead region includes a river routing region, the river routing region being an area where cell placement is excluded and preferred routing directions are modified to increase routing capacity, and wherein the hammerhead region expands an end of the river routing region laterally.

3. The integrated circuit of claim 2, wherein the hammerhead region includes a stair-step shaped expansion of the end of the river routing region.

4. The integrated circuit of claim 1, wherein the one or more routing congestion reduction regions includes a corner congestion reduction region located at a corner of one of the plurality of hard macros.

5. The integrated circuit of claim 4, wherein the corner congestion reduction region includes a stepped placement blockage region where cell placement is excluded, wherein the stepped placement blockage region includes at least one step region along an edge of the associated one of the plurality of hard macros.

6. The integrated circuit of claim 5, wherein the stepped placement blockage region further includes a non-preferred routing direction region, wherein the interconnect routing in the cell/routing region containing the corner congestion reduction region has preferred routing directions and wherein the preferred routing directions are modified in the non-preferred routing direction region.

7. The integrated circuit of claim 5, wherein the stepped placement blockage region further includes a routing density blockage region, wherein the interconnect routing in the cell/routing region containing the routing density blockage region has a maximum density of interconnect routing, and wherein the maximum density of interconnect routing in the routing density blockage region is reduced from the maximum density of interconnect routing for at least one of the plurality of metal layers.

8. The integrated circuit of claim 4, wherein the corner congestion reduction region includes a mesh placement blockage region, wherein the mesh placement blockage region includes a grid of blockage stripes, wherein cell placement is excluded from the blockage stripes.

9. The integrated circuit of claim 2, wherein the one or more routing congestion reduction regions further includes a halo region.

10. The integrated circuit of claim 9, wherein the preferred routing direction is the preferred routing direction of a first metal layer of the plurality of metal layers.

11. The integrated circuit of claim 9, wherein the halo region is located at an edge of one of the plurality of the hard macros.

12. The integrated circuit of claim 11, wherein the cell/routing region containing the halo region does not include cells in the halo region.

13. The integrated circuit of claim 1, wherein the one or more routing congestion reduction regions includes a halo region, and wherein the preferred routing direction is the preferred routing direction of a first metal layer of the plurality of metal layers.

14. The integrated circuit of claim 1, wherein the one or more routing congestion reduction regions includes a halo region, wherein the halo region is located at an edge of one of the plurality of the hard macros, and wherein the cell/routing region containing the halo region does not include cells in the halo region.

15. A method for developing an integrated circuit using a floorplan including a plurality of hard macros and a plurality of cell/routing regions, the cell/routing regions for placement of cells and routing of interconnects using a plurality of metal layers, the method comprising:
placing cells and preforming a global route of the integrated circuit based on a floorplan of the integrated circuit;
evaluating results of the global route for routing congestion;
modifying, based on the routing congestion, the floorplan by adding one or more routing congestion reduction regions to one or more of the plurality of cell/routing regions, the one or more routing congestion reduction regions selected from
a halo region located at an edge of one of the plurality of the hard macros, wherein interconnect routing in the cell/routing region containing the halo region has preferred routing directions and wherein the preferred routing directions are modified in the halo region,
a hammerhead region, wherein interconnect routing in the cell/routing region containing the hammerhead region has preferred routing directions, wherein the cell/routing region containing the hammerhead region includes a river routing region, the river routing region being an area where cell placement is excluded and preferred routing directions are modified to increase routing capacity, and wherein the hammerhead region expands an end of the river routing region laterally, and
a corner congestion reduction region located at a corner of one of the plurality of hard macros; and
placing cells and preforming a global route of the integrated circuit based on the modified floorplan.

16. The method of claim 15, wherein the modification of the preferred routing directions in the halo region includes modification of the preferred routing direction of a first metal layer of the plurality of metal layers.

17. The method of claim 15, wherein the corner congestion reduction region includes a stepped placement blockage region where cell placement is excluded, wherein the stepped placement blockage region includes at least one step region along an edge of the associated one of the plurality of hard macros.

18. The method of claim 17, wherein the stepped placement blockage region further includes a non-preferred routing direction region, wherein interconnect routing in the cell/routing region containing the corner congestion reduction region has preferred routing directions and wherein the preferred routing directions are modified in the non-preferred routing direction region.

19. The method of claim 17, wherein the stepped placement blockage region further includes a routing density blockage region, wherein interconnect routing in the cell/routing region containing the routing density blockage region has a maximum density of interconnect routing, and wherein the maximum density of interconnect routing in the routing density blockage region is reduced from the maximum density of interconnect routing for at least one of the plurality of metal layers.

20. The method of claim 15, wherein the corner congestion reduction region includes a mesh placement blockage region, wherein the mesh placement blockage region includes a grid of blockage stripes, wherein cell placement is excluded from the blockage stripes.

21. An integrated circuit, comprising:
a plurality of hard macros containing fixed circuits;
a plurality of cell/routing regions containing cells and interconnect routing using a plurality of metal layers; and
one or more means for reducing routing congestion located in one or more of the plurality of cell/routing regions.

22. The integrated circuit of claim 21, wherein the one or more means for reducing routing congestion includes a halo region located at an edge of one of the plurality of the hard macros, wherein the interconnect routing in the cell/routing region containing the halo region has preferred routing directions and wherein the preferred routing directions are modified in the halo region.

23. The integrated circuit of claim 21, wherein the one or more means for reducing routing congestion includes a hammerhead region, wherein the interconnect routing in the cell/routing region containing the hammerhead region has preferred routing directions, wherein the cell/routing region containing the hammerhead region includes a river routing region, the river routing region being an area where cell placement is excluded and preferred routing directions are modified to increase routing capacity, and wherein the hammerhead region expands an end of the river routing region laterally.

24. The integrated circuit of claim 21, wherein the one or more means for reducing routing congestion includes a corner congestion reduction region located at a corner of one of the plurality of hard macros.

25. A non-transitory computer readable medium comprising instructions that, when executed by a processor, cause the processor to perform operations for developing an integrated circuit using a floorplan including a plurality of hard macros and a plurality of cell/routing regions, the cell/routing regions for placement of cells and routing of interconnects using a plurality of metal layers, the instructions comprising instructions that cause the processor to:
place cells and perform a global route of the integrated circuit based on a floorplan of the integrated circuit;
evaluate results of the global route for routing congestion;
modify, based on the routing congestion, the floorplan by adding one or more routing congestion reduction regions to one or more of the plurality of cell/routing regions, the one or more routing congestion reduction regions selected from
a halo region located at an edge of one of the plurality of the hard macros, wherein interconnect routing in the cell/routing region containing the halo region has preferred routing directions and wherein the preferred routing directions are modified in the halo region,
a hammerhead region, wherein interconnect routing in the cell/routing region containing the hammerhead region has preferred routing directions, wherein the cell/routing region containing the hammerhead region includes a river routing region, the river routing region being an area where cell placement is excluded and preferred routing directions are modified to increase routing capacity, and wherein the hammerhead region expands an end of the river routing region laterally, and
a corner congestion reduction region located at a corner of one of the plurality of hard macros; and
place cells and perform a global route of the integrated circuit based on the modified floorplan.

26. The non-transitory computer readable medium of claim 25, wherein the modification of the preferred routing directions in the halo region includes modification of the preferred routing direction of a first metal layer of the plurality of metal layers.

27. The non-transitory computer readable medium of claim 25, wherein the corner congestion reduction region includes a stepped placement blockage region where cell placement is excluded, wherein the stepped placement blockage region includes at least one step region along an edge of the associated one of the plurality of hard macros.

28. The non-transitory computer readable medium of claim 27, wherein the stepped placement blockage region further includes a non-preferred routing direction region, wherein interconnect routing in the cell/routing region containing the corner congestion reduction region has preferred routing directions and wherein the preferred routing directions are modified in the non-preferred routing direction region.

29. The non-transitory computer readable medium of claim 27, wherein the stepped placement blockage region further includes a routing density blockage region, wherein interconnect routing in the cell/routing region containing the routing density blockage region has a maximum density of interconnect routing, and wherein the maximum density of interconnect routing in the routing density blockage region is reduced from the maximum density of interconnect routing for at least one of the plurality of metal layers.

30. The non-transitory computer readable medium of claim 25, wherein the corner congestion reduction region includes a mesh placement blockage region, wherein the mesh placement blockage region includes a grid of blockage stripes, wherein cell placement is excluded from the blockage stripes.
